(19) United States
(12) Patent Application Publication
(10) Pub. No.: US 2006/0225824 A1
(43) Pub. Date: Oct. 12, 2006

(54) Pneumatic tire

(76) Inventors: Masatoshi Kuwajima, Kanagawa (JP); Kenji Yamane, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/568,145

(22) PCT Filed: Aug. 3, 2004
(86) PCT No.: PCT/JP04/11074

§ 371 Date: Feb. 13, 2006

(30) Foreign Application Priority Data
Aug. 28, 2003 (JP) 2003-304878

(51) Int. Cl. B60C 9/18

(52) U.S. Cl. 152/527; 152/531

(57) ABSTRACT

Disclosed is a pneumatic radial tire allowed to compatibly enhance its high-speed durability and to reduce road noise. In the tire, a plurality of belt layers 3 are arranged on an outer periphery of a carcass layer 2, and a belt reinforcement layer 4, which is formed of reinforcing cords spirally wound up substantially in a circumferential direction, is arranged in the vicinity of the belt layers. While an overhanging length L, by which the belt reinforcement layer 4 overhangs from an end of a maximum-width portion of the belt layers, is set in a range of 5 to 20 mm, an intermediate elongation of the reinforcing cords of the belt reinforcement layer 4 under a load of 67 N is set in a range of 1.5 to 5.5%.

### TECHNICAL FIELD

The present invention relates to a pneumatic radial tire, and more specifically, the present invention relates to a pneumatic radial tire allowed to enhance its high-speed durability as well as to reduce road noise by improving a belt reinforcement layer.

### BACKGROUND ART

Generally, in a pneumatic radial tire designed for high-speed traveling, with respect to a belt layer arranged inside a tread portion, a belt reinforcement layer, which is formed by spirally winding up a thermally shrinkable nylon cord substantially in a circumferential direction of the tire, is arranged to an outer periphery thereof. By restraining both ends of the belt layer from being forced to move upward due to a centrifugal force during high-speed traveling, this belt reinforcement layer prevents these ends from being separated from a rubber layer, whereby high-speed durability of the tire is ensured.

Patent Document 1 proposes that, in a pneumatic radial tire thus provided with a belt reinforcement layer, a road noise reduction effect in addition to high-speed durability enhancement should be obtained by using, as reinforcing cords for the belt reinforcement layer, organic fibers having a small intermediate elongation. As a result of conducting further examinations on configuration of the belt reinforcement layer by use of reinforcing cords having a low intermediate elongation, inventors of the present invention and others gained knowledge that if an overhanging length, by which an end of the belt reinforcement layer overhangs from an end of the belt layer, is lengthened to have at least a certain length, a road noise reduction effect is increased with decreasing intermediate elongation of the reinforcing cords. Additionally, they gained knowledge that this effect becomes more remarkable if the intermediate elongation thereof is made not more than 5.5%. However, knowledge was also gained that, if an intermediate elongation thereof is made too small, although the elongation substantially reduces road noise, the elongation also makes the reinforcing cords to bite deeply into the rubber layer, whereby high-speed durability of the tire is reduced.

[Patent Document 1] Japanese patent application Kokai publication No. 2001-180220

### DISCLOSURE OF THE INVENTION

An object of the present invention is to provide, by devising ways of using reinforcing cords having a low intermediate elongation, a pneumatic radial tire whereby road noise reduction and high-speed durability enhancement are compatibly achieved.

The present invention which achieves the above object is a pneumatic radial tire where a plurality of belt layers are arranged on an outer periphery of a carcass layer, and where a belt reinforcement layer formed of reinforcing cords spirally wound round substantially in a circumferential direction of the tire is arranged in the vicinity of the belt layers. The pneumatic radial tire is characterized in that, while an overhanging length, by which an end of the belt reinforcement layer overhangs from an end of a maximum-width portion of the belt layers, is set in a range of 5 to 20 mm, an intermediate elongation of reinforcing cords of the belt reinforcement layer under a load of 67 N is set in a range of 1.5 to 5.5%.

More preferably, the pneumatic radial tire is characterized in at least any one of the following three. First, an outer diameter of the belt reinforcement layer at the center of a tread is set to be 1.065 to 1.13 times an outer diameter of a terminal of the belt reinforcement layer. Second, an intermediate elongation of the reinforcing cords in a region of the belt reinforcement layer overhanging from the end of the belt layer is set larger than an intermediate elongation of the reinforcing cords in a region thereof overlapping the belt layer. Third, cord-to-cord distances from the belt reinforcement layer respectively to the belt layer and to the carcass layer are set to at least 0.5 mm in a region between a position, which is reached by extending an end of a maximum-width portion of the belt layers inwardly in a widthwise direction of the tire by at least 5% of a maximum width of the belt layer, and a terminal of the belt reinforcement layer.

According to the present invention, by increased stiffness of a tread shoulder portion of the tire, road noise reduction as well as high-speed durability enhancement can be achieved in the abovementioned manner that, while an intermediate elongation under a load of 67 N (hereinafter, simply referred to as intermediate elongation) of the reinforcing cords constituting the belt reinforcement layer is set as small as 1.5 to 5.5%, the overhanging length, by which the belt reinforcement layer follows the carcass layer beyond the end of the maximum-width belt layer, is set in a range of 5 to 20 mm which is considerably long.

In the case where the outer diameter of the belt reinforcement layer at the tread center is additionally set 1.065 to 1.13 times the outer diameter of the belt reinforcement layer terminal, a difference is small between outer diameters respectively of the overhanging portion of the belt reinforcement layer and of the tread center. Accordingly, a load received by the belt reinforcement layer formed of reinforcing cords having a small intermediate elongation is reduced, whereby it becomes possible to prevent durability of the belt reinforcement layer terminal from being deteriorated. Furthermore, in the case where an intermediate elongation of the reinforcing cords in the overhanging region of the belt reinforcement layer is set larger than that of the reinforcing cords in the other region thereof overlapping the belt layer, it becomes possible to enhance durability of the belt reinforcement layer terminal which receives a heavy load.

Additionally, it becomes possible to restrain cord-to-cord contact from occurring due to the reinforcing cords biting into the belt layer and the carcass layer, and hence to prevent a damage otherwise caused by the cord-to-cord contact, in the case where cord-to-cord distances from the belt reinforcement layer respectively to the belt layer and to the carcass layer are set to at least 0.5 mm in a region between a terminal of the belt reinforcement layer and a position reached by extending an end of a maximum-width portion of the belt layers inwardly in a widthwise direction of the tire by at least 5% of a maximum width of the belt layer.

### BRIEF DESCRIPTION OF THE DRAWINGS

FIG. 1 is a half cross-sectional view showing a main portion of a tread region of a pneumatic radial tire formed of an embodiment of the present invention.

### BEST MODE FOR CARRYING OUT THE INVENTION

A tire applied to the present invention is a pneumatic radial tire where a belt layer is arranged inside a tread thereof. At the same time, the present invention is intended for a tire where a belt reinforcement layer formed by reinforcing cords wound up substantially in a circumferential direction of the tire is arranged in the vicinity of the belt layer for the purpose of strengthening high-speed durability of the tire, and is particularly intended for a pneumatic radial tire for a passenger automobile. While the belt layer generally has its belt cords formed of steel cords, there may be cases where organic fiber cords, such as aramid cords, having a high modulus of elasticity are used partially or entirely in the belt layer.

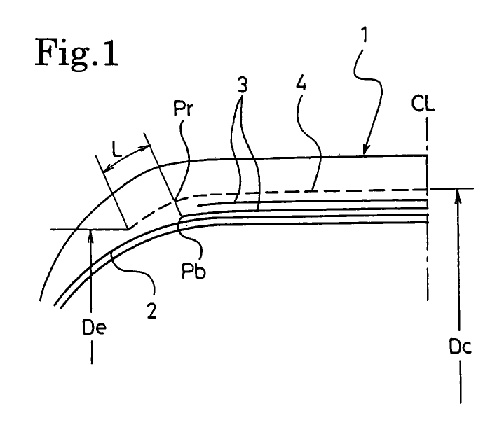

FIG. 1 shows an embodiment of a pneumatic radial tire of the present invention by illustrating a main portion thereof in a half cross-sectional view.

Reference numeral 1 is a tread portion, and reference numeral 2 denotes a carcass layer arranged inside the tire. To an outer periphery of the carcass layer 2, two vertically layered belt layers 3 are arranged, and furthermore, to an outer periphery of the belt layers 3, a belt reinforcement layer 4 is arranged. The reinforcing cords of the belt reinforcement layer 4 are wound up substantially in the circumferential direction of the tire. Additionally, while the belt reinforcement layer 4 extends over an entire width of the belt layers 3 in a widthwise direction of the tire, both ends thereof noticeably overhang outside the belt layers 3.

As the reinforcing cords constituting the belt reinforcement layer 4, cords whose intermediate elongation is in a range as small as 1.5 to 5.5% are used. An overhanging length L of the belt reinforcement layer 4 is formed in order that it overhangs in a larger amount than one in a regular tire. Specifically, the overhanging length L is formed preferably in a range of 5 to 20 mm, and more preferably in a range of 10 to 20 mm, if it is expressed as a periphery length following the belt reinforcement layer 4 from an intersection Pr of the belt reinforcement layer 4 and a vertical line drawn from an end Pb of the widest one (the inside belt layer) of the belt layers 3.

The pneumatic tire of the present invention enhances high-speed durability whereby destruction of the edges of the belt layers due to high-speed traveling is suppressed, in the abovementioned manner that, while cords having an intermediate elongation as small as 1.5 to 5.5%, which is preferably 2.5 to 5.5% and is more preferably 3.0 to 5.0%, are used as the reinforcing cords constituting the belt reinforcement layer, the overhanging length L by which the belt reinforcement layer overhangs from the end of the maximum-width belt layer is formed to be as large as preferably 5 to 20 mm, or more preferably 10 to 20 mm. Moreover, stiffness of a tread shoulder portion of the tire is increased in that manner, whereby road noise can be considerably reduced.

For the reinforcing cords of the belt reinforcement layer, an organic fiber cords are preferably used. For the organic fiber cords, cords whose intermediate elongation is in a range of 1.5 to 5.5% in a vulcanized tire and in a state where they are taken out from a vulcanized tire are used. By setting the intermediate elongation of the reinforcing cords to be in a range of 1.5 to 5.5% in a vulcanized tire, initial tension thereof is brought into a high-tension state, whereby the belt reinforcement layer can perform, on the end of the belt layer, a hooping effect and/or prevention of forcedly moving upward.

If the overhanging length L of the belt reinforcement layer is made shorter than 5 mm, it becomes more difficult to obtain the above effects. On the other hand, if the overhanging length L is made longer than 20 mm, the belt reinforcement layer becomes more likely to be damaged because of the small intermediate elongation of the reinforcing cords. Additionally, if an intermediate elongation of the reinforcing cords is made larger than 5.5%, it becomes impossible to obtain a considerable road noise reduction effect. On the other hand, if an intermediate elongation of the reinforcing cords is made smaller than 1.5%, the belt reinforcement layer itself becomes more likely to be damaged, whereby high-speed durability of the tire is reduced. A lower limit for the intermediate elongation is preferably 2.5%, and more preferably 3.0%.

Moreover, with respect to a relation between the overhanging length L of the belt reinforcement layer and an intermediate elongation of the reinforcing cords, in the above-mentioned range, if the overhanging length L of the belt reinforcement layer is set relatively short so as to be in a range of 5 to 15 mm in a case of using a reinforcing cords having a relatively small intermediate elongation which is in a range of 2.4 to 4.5%, compatible achievement of high-speed durability and a road noise reduction effect can be still more favorable. On the other hand, if the overhanging length L of the belt reinforcement layer is set relatively long so as to be in a range of 15 to 20 mm in a case of using reinforcing cords having a relatively large intermediate elongation which is in a range of 3.5 to 5.5%, compatible achievement of high-speed durability and a road noise reduction effect can be similarly still more favorable. In other words, in the case where an intermediate elongation of reinforcing cords is larger, toughness of the belt reinforcement layer is higher and breaking thereof is not likely to occur even with increasing overhanging length thereof. Accordingly, in that case, road noise reduction effect can be reduced by having the overhanging length larger.

In the pneumatic tire of the present invention, since the belt reinforcement layer formed of reinforcing cords having a low intermediate elongation is used as described above, an outer diameter Dc of the belt reinforcement layer at the tread center may be set 1.065 to 1.13 times an outer diameter De of a terminal in the overhanging portion of the belt reinforcement layer, in light of retaining durability thereof in a favorable state. By having this relation, a difference is made small between outer diameters respectively at the terminal in the overhanging portion of the belt reinforcement layer and at the tread center. Accordingly, a load received by the terminal of the belt reinforcement layer is reduced even with a reinforcing cords having a small intermediate elongation, whereby it becomes possible to prevent durability of the belt reinforcement layer from being deteriorated.

Moreover, by using different kinds of reinforcing cords respectively in the overhanging portion of the belt reinforcement layer and in a region thereof overlapping the belt layer, an intermediate elongation of the reinforcing cords in the overhanging portion may be set larger than an intermediate elongation of the reinforcing cords in the region overlapping the belt layer. By thus making larger the intermediate elongation of the reinforcing cords in the overhanging portion, toughness of the overhanging portion is increased, and hence durability of the belt reinforcement layer can be enhanced. For example, it is applicable that, while reinforcing cords whose intermediate elongation is 2.5% be used in a region of the belt reinforcement layer overlapping an end of the belt layer, reinforcing cords whose intermediate elongation is 5.5% be used in the overhanging portion thereof. In the case described herein, an intermediate elongation of reinforcing cords in a region where the belt reinforcement layer overlaps the tread center may be equal to, or may be larger than, an intermediate elongation of reinforcing cords in a region where it overlaps an end of the belt layer.

Moreover, in a region between a terminal of the belt reinforcement layer and a position reached by extending an end of a maximum-width portion of the belt layers inwardly in a widthwise direction of the tire by at least 5% of a maximum-width measurement of the belt layers, it is preferable that cord-to-cord distances from the belt reinforcement layer respectively to the belt layer and to the carcass layer are set between 0.5 mm and 1.5 mm inclusive. While the tire is molded by vulcanization, reinforcing cords having a small intermediate elongation, when being pushed up by a bladder toward a inside surface of a mold, bite into a rubber layer and go into a state where they make contact with cords in the belt layer and the carcass layer. Subsequently, in some cases, this cord-to-cord contact may lead to reduction in the high-speed durability. By making the cord-to-cord distances from the belt reinforcement layer respectively to the belt layer and to the carcass layer in the above region to be at least 0.5 mm, the cord-to-cord contact can be avoided, whereby reduction in the high-speed durability can be prevented. However, if the cord-to-cord distances are made larger than 1.5 mm, a road noise reduction effect is decreased.

In the present invention, other than to the outer periphery of the multilayered belt layers as shown in the illustrated example, the belt reinforcement layer may be arranged between the belt layers, or may be arranged between the belt layer and the carcass layer. Accordingly, arranging the belt reinforcement layer in the vicinity of the belt layer in the present invention includes, other than a case of arranging it to an outer periphery of the multilayered belt layer, such a case as arranging it between layers of the multilayered belt layers and arranging it between an inner periphery of the multilayered belt layers and the carcass layer. Otherwise, the above arrangements may be combined so that a plurality of reinforcement layers can be arranged.

The belt reinforcement layer is formed by winding up reinforcing cords in order that they are arrayed substantially in a circumferential direction of the tire. The term “substantially in a circumferential direction” is used not only for a case where the reinforcing cords are relative to the circumferential direction of the tire at 0 degree but also for a case where they are relative thereto at 15 degrees or less, in the sense that being relative thereto at 15 degrees or less is considered equivalent to being in the circumferential direction of the tire. Additionally, the belt reinforcement layer may be arranged at least in a manner that it covers both ends of the belt layer and is extended out of these ends, and may not be necessarily configured to cover a full width of the belt layers. However, preferable is the belt reinforcement layer which, as shown in the illustrated example, covers the full width of the belt layers.

As a method of forming the belt reinforcement layer, any one of publicly known methods is applicable. Preferably, in light of productivity, it is suitable to use a method of forming it by spirally winding up, substantially in the circumferential direction of the tire, a strip material obtained by aligning together and rubberizing a plurality (any number roughly in a range of 2 to 30) of reinforcing cords. Although a width of the strip material is not particularly limited, it is preferable that the width is set in a range roughly of 3 to 20 mm.

As a method of forming the belt reinforcement layer used in the present invention, another method, although this method is somewhat worse in productivity, may be used. This method is one where: by bias-cutting a sheet material, which is obtained by aligning together and rubberizing multiple reinforcing cords, in a direction along which the reinforcing cords are extended, only a portion thereof corresponding to one circumference of the tire is taken out; this portion is wound up in the circumferential direction of the tire; and both ends thereof are spliced with each other.

A kind of the organic fiber cords used for the reinforcing cords in the belt reinforcement layer is not particularly limited as long as that is one whose intermediate elongation becomes 1.5 to 5.5% in a vulcanized tire. Polyethylene terephthalate (PET), polyethylene-2,6-naphthalate (PEN), aromatic polyamide, poly-p-phenylenebenzobisoxazole, polyvinyl alcohol, nylon, and the like can be cited as examples for the kind. Among them, particularly, polyethylene terephthalate and polyethylene-2,6-naphthalate are preferable.

These organic fiber cords may be formed of one polymer, or may be formed of two or more polymers. In the case where the organic fibers are formed of two or more polymers, the organic fiber cords may be formed by stretching and aligning, or by twisting, two or more kinds of fiber cords, each of the kinds being formed of one of the polymers. Alternatively, they may be fiber cords using bicomponent yarn, which is spun in a sheath-core configuration, or in a bimetal configuration, out of two or more polymers in liquid form, through the same spinning orifice. As an example for the bicomponent yarn, sheath-core type bicomponent yarn where polyester, such as polyethylene terephthalate or polyethylene-2,6-naphthalate, is used as a core and nylon is used as a sheath can be cited.

### Examples 1 to 8

Pneumatic radial tires of twelve kinds (Examples 1 to 8, Conventional Examples 1 and 2, and Comparative Examples 1 and 2) were prepared in the following manner. They had common conditions that their tire size was 225/50R17; that they had the tire structure shown in FIG. 1; and that a polyethylene terephthalate thread was used as reinforcing cords of the belt reinforcement layer. Overhanging lengths L (mm), by which belt reinforcement layers overhang from ends of widest belt layers of the respective tires, and intermediate elongations E (%) under a load of 67 N of the reinforcing cords were made different among them as shown in Table 1.

With respect to the pneumatic radial tires of these twelve kinds, road noise and high-speed durability were assessed in the following testing methods, and results of the assessment are shown in Table 1 in index numbers found by setting results for Conventional Example 1 at 100 (the larger the index number is, the better the assessment is). The results shown in Table 1 show that the all tires used in Examples 1 to 8 are excellent in road noise reduction effect and high-speed durability.

[Road Noise]

Each of the test tires was mounted onto a standard rim specified by the JATMA standard, was inflated with an air pressure of 200 kPa, and then was installed to a passenger automobile having an engine displacement of 3000 cc. Then, a microphone was installed at a position corresponding to an ear of a driver on a window side in a driver's seat in a car interior of the automobile, and a sound pressure level (dB(A)) of road noise in a frequency band of 250 to 400 Hz when traveling on a rough pavement at 50 km/h was assessed.

[High-Speed Durability]

Immediately after a high-speed durability testing method specified by JIS D4230 was applied to each of the test tires by using a rotating drum with a dram diameter of 1707 mm, it was run with increases in speed by 10 km/h every 10 minutes. The high-speed durability was evaluated by a magnitude of speed when each of the tires was destroyed.

TABLE 1

| | | | | High-speed |
|---|---|---|---|---|
| | Intermediate | Overhanging | Road noise | durability |
| | elongation | length | (index | (index |
| | E (%) | L (mm) | number) | number) |
| Example 1 | 5.5 | 10 | 103 | 100 |
| Example 2 | 5.5 | 20 | 105 | 100 |
| Example 3 | 5.0 | 10 | 104 | 100 |
| Example 4 | 4.5 | 20 | 105 | 104 |
| Example 5 | 2.5 | 10 | 106 | 108 |
| Example 6 | 2.5 | 20 | 107 | 104 |
| Example 7 | 1.5 | 10 | 106 | 104 |
| Example 8 | 4.5 | 5 | 102 | 100 |
| Conventional | 5.0 | 3 | 100 | 100 |
| Example 1 | | | | |
| Conventional | 6.0 | 3 | 100 | 100 |
| Example 2 | | | | |
| Comparative | 5.0 | 25 | 106 | 96 |
| Example 1 | | | | |
| Comparative | 1.5 | 25 | 108 | 92 |
| Example 2 | | | | |

1. A pneumatic radial tire where a plurality of belt layers are arranged on an outer periphery of a carcass layer, and where a belt reinforcement layer, which is formed of reinforcing cords spirally wound up substantially in a circumferential direction of the tire, is arranged in the vicinity of the belt layers,
wherein, while an overhanging length, by which the belt reinforcement layer overhangs from an end of the maximum-width portion of the belt layers, is set in a range of 5 to 20 mm, an intermediate elongation of reinforcing cords of the belt reinforcement layer under a load of 67 N is set in a range of 1.5 to 5.5%.

2. The pneumatic radial tire according to claim 1, wherein an outer diameter of the belt reinforcement layer in a tread center portion of the tire is set to be 1.065 to 1.13 times an outer diameter of a terminal of the belt reinforcement layer.

3. The pneumatic radial tire according to any one of claims 1 and 2, wherein an intermediate elongation of the reinforcing cords in a region of the belt reinforcement layer overhanging from the end of the belt layer is set larger than an intermediate elongation of the reinforcing cords in a region thereof overlapping the belt layer.

4. The pneumatic radial tire according to claim 1, wherein cord-to-cord distances from the belt reinforcement layer respectively to the belt layer and to the carcass layer are set between 0.5 mm and 1.5 mm inclusive in a region between: a terminal of the belt reinforcement layer and a position reached by extending an end of a maximum-width portion of the belt layers inwardly in a widthwise direction of the tire by at least 5% of a maximum width of the belt layers.

5. The pneumatic radial tire according to claim 1, wherein the belt reinforcement layer is formed by spirally winding up, substantially in the circumferential direction of the tire, a strip material obtained by aligning and rubberizing a plurality of reinforcing cords.
